(19) United States
(12) Patent Application Publication
(10) Pub. No.: US 2006/0000057 A1
(43) Pub. Date: Jan. 5, 2006

(54) Charlie the doorman an automatic storm door holding open device retrofitable to existing air over spring cylinder door closers

(76) Inventor: John Henry Rossio, Inverness, FL (US)

Correspondence Address: JOHN HENRY ROSSIO, 6000 E. DELL LANE, INVERNESS, FL, 34452, US

(21) Appl. No.: 10/880,136

(22) Filed: Jun. 30, 2004

(51) Int. Cl. E05F 5/02

(52) U.S. Cl. 16/82

(57) ABSTRACT

When applied to an existing or new cylinder type door closer, The user can open and maintain the door fully open by using only the door handle. My invention is comprised of a cylindrical sleeve, made in two longitudinal snaped together halves. This sleeve closely surrounds the cylinder while allowing the cylinder free movement with in. One end is joined at the door jamb mounting bracket and piston rod end by a new two ended connecting pen. To hold the door fully open a spring or gravity actuated latch is embodied in one half of the sleeve. The latch rides on the cylinder until it achieves it,s full reach. At this point the latch automatically extends past the face of the cylinder preventing the cylinders return. To close the door the latch is manually retracted. Additional manual only latches are also embodied in the sleeve for intermediate door open positions.

My invention is a cyjindrical tube made in two halves with a special interlocking latch at a point where the two halves meet. This tube when slid over an existing door closing cylinder and attaches with a common pivoting pin at the door jamb bracket. A spring loaded pin is located on the top half of the tube at a point near the full reach of the closing cylinder. When the cylinder attains its full reach the spring driven pin moves down past the face of the cylinder and prevents its return. To close the door push the door open removing the pressure on the pin and lift and hold the pin as the cylinder returns. Constructing the my invention in two halves facilitates both manufacturing and installation.

### BACKGROUND OF THE INVENTION

My invention falls in the Classification Definitons under Door Closures. In general the air over spring cylinder door closure work well. However for many wears a problem with holding the door open conveniently has persisted. Currently this is accomplished by sliding a bent washer along the piston rod to contact the face of the cylinder ware the washer tilts and binds the rod with cylinder face as it trys to return. This operation requires two hands one to hold the door and one to slide the washer. many fingers have been pinched in this process. Two new products are now on the market. The first controls the bent washer at the of the cylinder thus when door open position is attained a lever provided tilts the washer and stops the door. To close the door the door is opened and a spring returns the washer to its slidable position. The second and newest design is a collet clamping device that gripes the piston shaft, this collet is embodied at the cylinder face, A rotatable color is rotated thus locking and unlocking the at the required location. The first design is Touch n Hold By national Mfg. Co. Sterling Ill. Made In Romania no patt. no. The second design is by Wright Products Rice Lake Ws. also no patt. no. model no. 99308-000 rev-b

In closing my design provides what has long been needed 1. a safe mechanism covering 2. options for holding the door open at preset intervals 3. automatic one hand positioning of the door in its full open position with the use of one hand.

### DETAILED DESCRIPTION OF THE INVENTION

My invention should be made of molded plastics or other ridged material. It should come in as many sizes to accomidate existing door clousers as well designs to come. My invention brings to the comminley used cylinder a safe neat aperance with the addition the ability to open and lock a storm door at full open with the use of one hand.

### SUMMARY OF INVENTION

My invention enables a person with special needs to open a storm door fully with only one hand. A mother with a child in one arm standing on an icy porch can bring the storm to its full open and lock position as she proceeds in.

### DESCRIPTION OF DRAWINGS

Drawing 1.

Is a typical house entrance in plan view showing a typical cylinder type door closer FIG. 1 Also shown a detail of a bent washer clamp. FIG. 2.

Drawing 2.

Shows in simplest terms my invention. A ridged reach from the pivot point E. to a point just beyond the cylinder face there a guide is afixed to seed reach. This guide follows the cylender as it moves M. Also shown automatic and manual stops K. L. FIG. 2. FIG. 4. 5. show a rectangular embodement.

Drawing 3.

Shows a tubular embodement having two halves G. I.

Drawing 4.

Shows sections of the liner latch FIG. 10 and a manual stop FIG. 4.

Drawing 5.

Shows sections of spring actuated stops FIG. 6. FIG. 7.

Drawing 6.

shows a cylinderical embodiment with toggle style stops. FIG. 13. and FIG. 14.

Drawing 7.

FIG. 15. is proposed final design for my invention. FIG. 16. is of an enlarged foot pedal over a spring stop. FIG. 17. is of my special pivot pin.

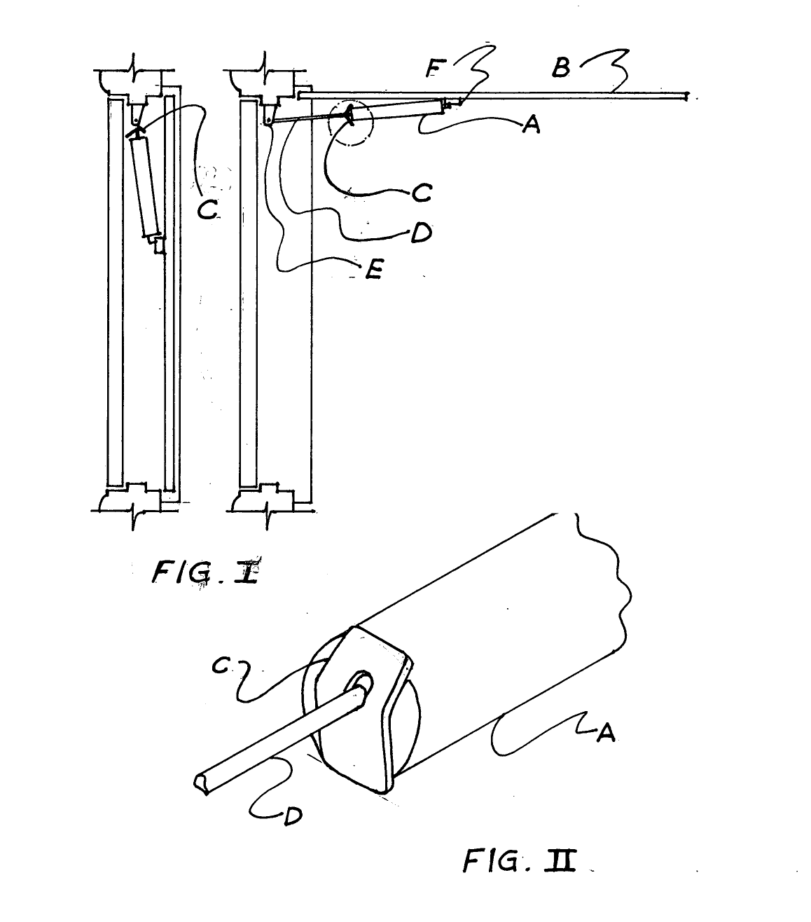

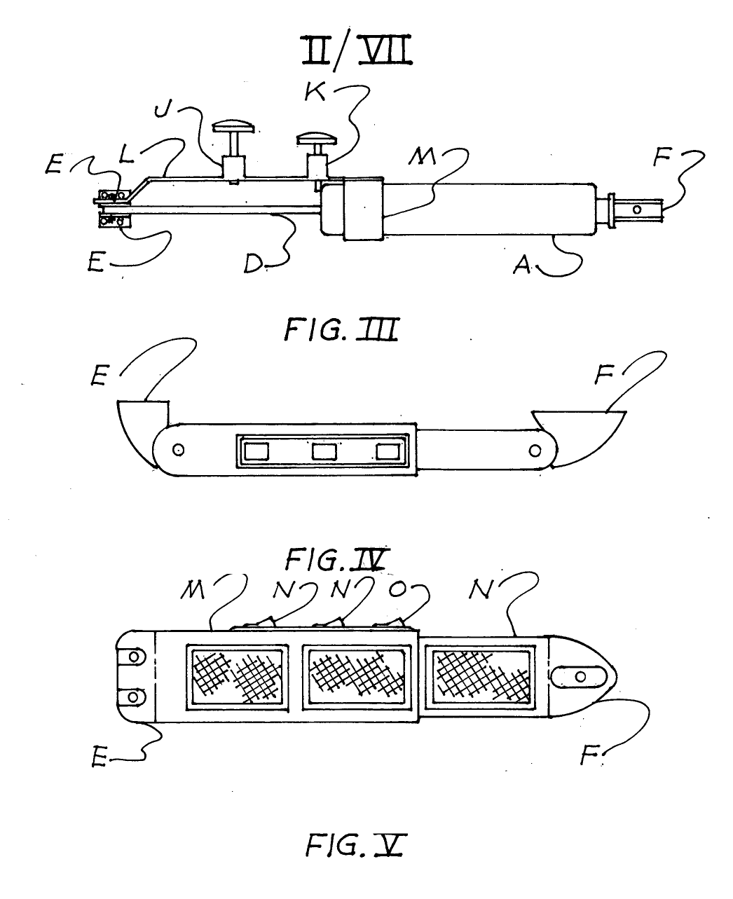

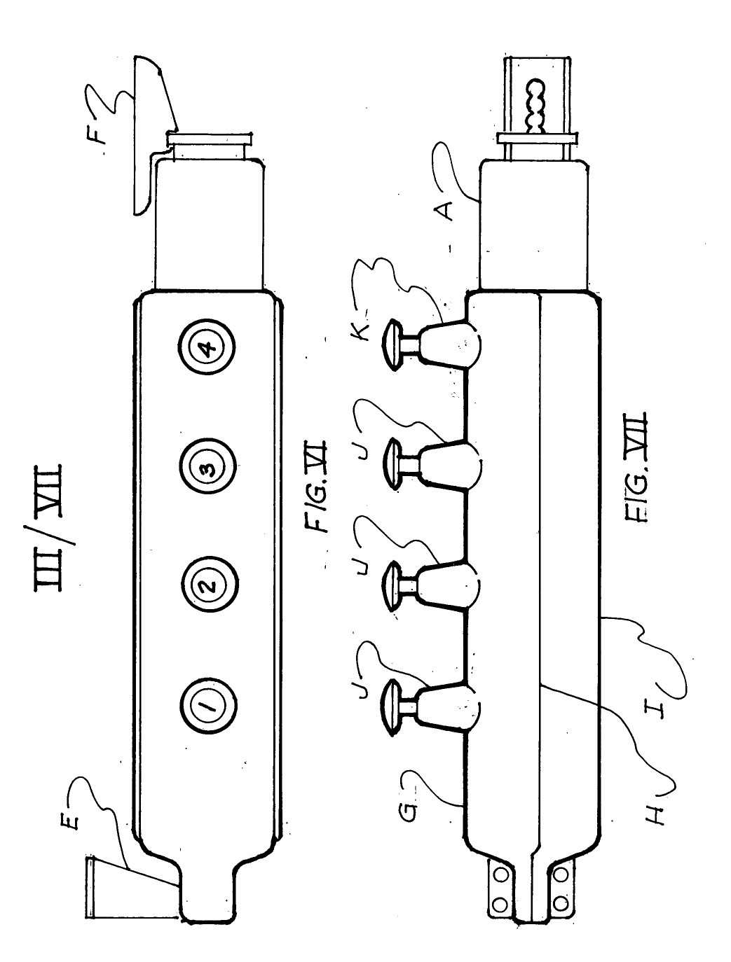

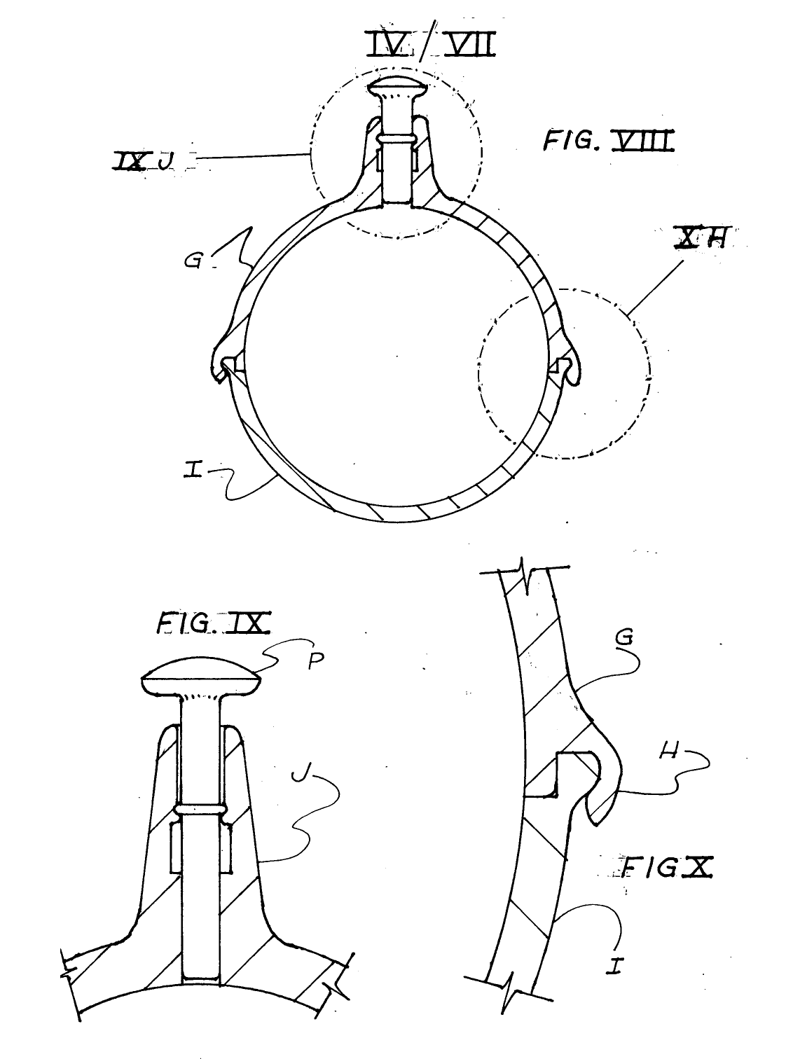

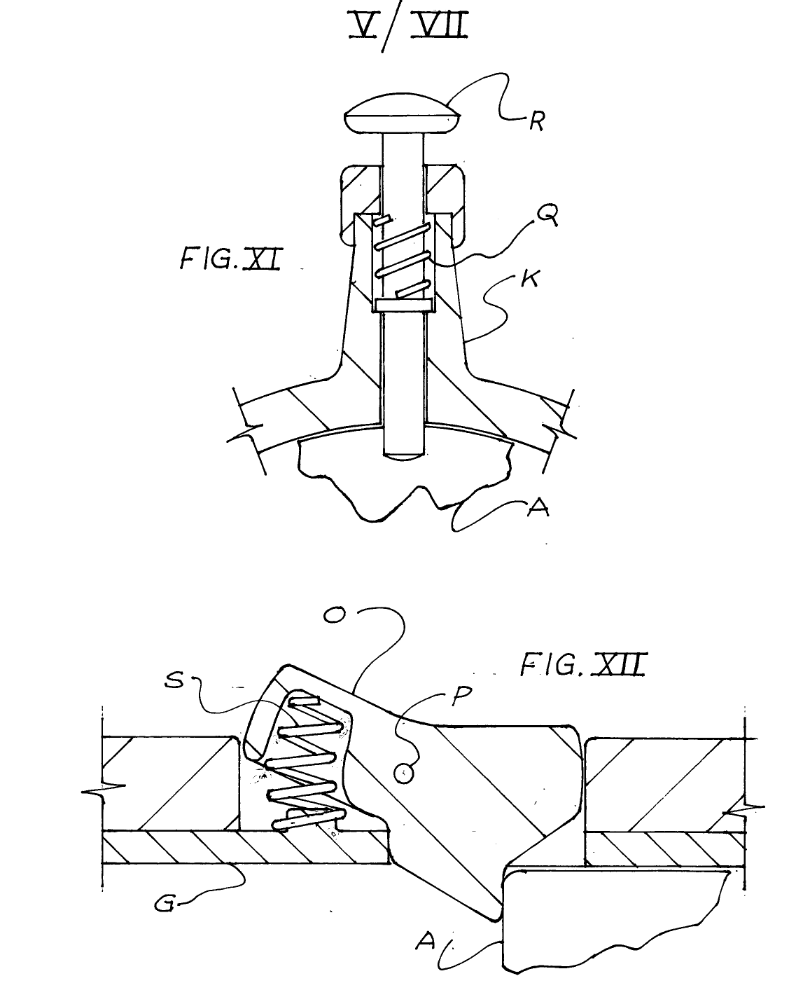

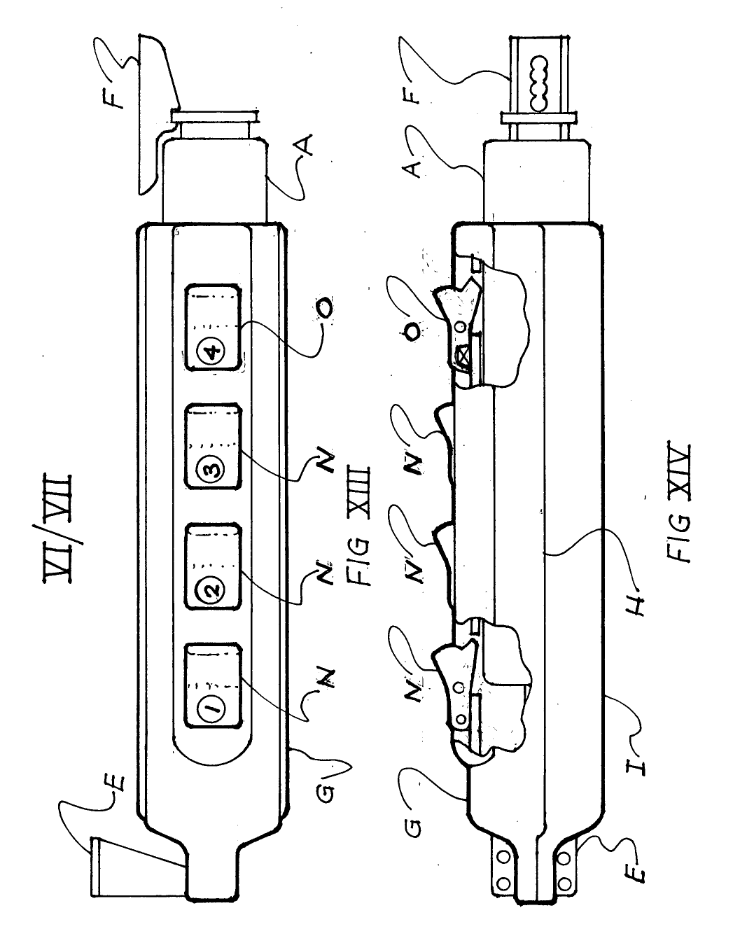

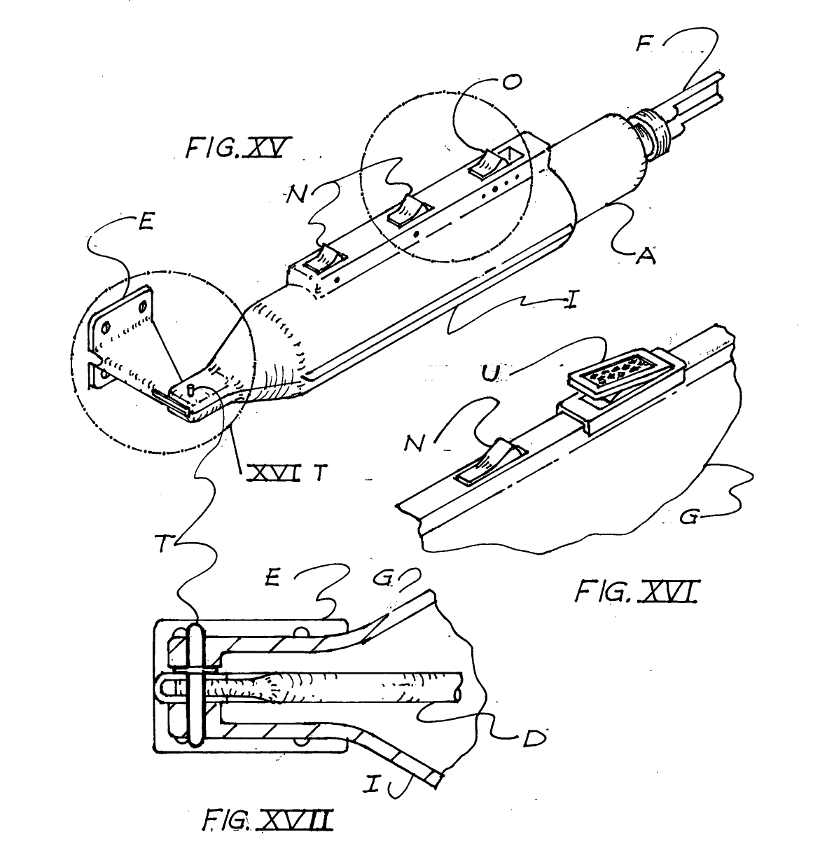

1. I claim a ridged reach connected to a stationary bracket and a piston rod end by means of a common link pin. Sade reach extends to point beyond the face of the cylender at this point guide interacts with the cylinder while allowing the cylinder free movement. This ridged reach provides a platform where on can be placed manully and springadley operated cylinder return stops.

2.
